(19) United States
(12) Patent Application Publication
(10) Pub. No.: US 2025/0071689 A1
(43) Pub. Date: Feb. 27, 2025

(54) SYSTEM AND METHOD FOR CONTROLLING RADIATED POWER

(71) Applicant: Samsung Electronics Co., Ltd., Suwon-si (KR)

(72) Inventors: Mahmoud Esam Mohamed Ahmed ABDELGELIL, San Diego, CA (US); Wan Jong KIM, Tustin, CA (US); Pranav DAYAL, San Diego, CA (US)

(21) Appl. No.: 18/677,761

(22) Filed: May 29, 2024

Related U.S. Application Data
(60) Provisional application No. 63/534,522, filed on Aug. 24, 2023.

(51) Int. Cl. H04W 52/22; H04B 7/06; H04W 52/36

(52) U.S. Cl. CPC H04W 52/228; H04W 52/367; H04B 7/06

(57) ABSTRACT

A system and method for controlling radiated power. In some embodiments, a device includes: a first radio; a second radio; and one or more processors; and a memory storing instructions which, when executed by the one or more processors, cause performance of: determining that a first transmission, of the first radio, is transmitted at a first power level greater than zero and less than a first threshold, and in response to determining that the first transmission of the first radio is transmitted at a first power level less than the first threshold, causing the second radio to transmit a second transmission at a second power level, wherein the second power level is determined based at least in part on the first power level and the first threshold.

### CROSS-REFERENCE TO RELATED APPLICATION

This application claims the priority benefit under 35 U.S.C. § 119(e) of U.S. Provisional Application No. 63/534,522, filed on Aug. 24, 2023, the disclosure of which is incorporated by reference in its entirety as if fully set forth herein.

### TECHNICAL FIELD

The disclosure generally relates to wireless communications. More particularly, the subject matter disclosed herein relates to improvements to controlling radiated power in wireless devices.

### SUMMARY

Wireless devices may emit radiation (e.g., radio frequency radiation, such as microwave radiation) that may to some extent be absorbed by tissues of a user of such a device.

To solve this problem regulatory agencies have specified limits on the power emitted by wireless devices.

One issue with the above approach is that in wireless devices with multiple radios or multiple antennas, a fixed respective fraction of the total power limit may be allocated to each radio or to each antenna. This may result in relatively poor performance when, for example, one antenna radiates power at a level that is set based on the assumption that each other antenna is radiating the full amount of power allocated to it, even when one or more other antenna is transmitting less than the full amount of power allocated to it.

To overcome these issues, systems and methods are described herein for dynamically reallocating power limits among a plurality of antennas or radios in a wireless device.

The above approaches improve on previous methods because they enable a wireless device to transmit at a total power level that is nearer the power limit, allowing the device to achieve improved performance.

According to an embodiment of the present disclosure, there is provided a device including: a first radio; a second radio; and one or more processors; and a memory storing instructions which, when executed by the one or more processors, cause performance of: determining that a first transmission, of the first radio, is transmitted at a first power level greater than zero and less than a first threshold, and in response to determining that the first transmission of the first radio is transmitted at a first power level less than the first threshold, causing the second radio to transmit a second transmission at a second power level, wherein the second power level is determined based at least in part on the first power level and the first threshold.

In some embodiments, the second power level is less than or equal to the sum of the first threshold and a difference between the first threshold and the first power level.

In some embodiments, the second power level is less than or equal to the sum of a second threshold and a difference between the first threshold and the first power level, wherein the second threshold is different than the first threshold.

In some embodiments, the first power level of the first radio is a time-averaged power level of the first radio.

In some embodiments, the first power level is an increment-average power level of the first radio.

In some embodiments, the first threshold is a set fraction of a compliance power limit.

In some embodiments, the first radio includes a first transmitting antenna, and the second radio includes a second transmitting antenna, co-located with the first transmitting antenna.

In some embodiments, the device further includes a third radio including a third transmitting antenna, the third transmitting antenna not being co-located with the second transmitting antenna, wherein the instructions, when executed by the one or more processors, further cause performance of determining the second power level based on quantities not including a power level of a transmission transmitted by the third transmitting antenna.

In some embodiments, the instructions, when executed by the one or more processors, further cause performance of: determining that a third transmission, of the second radio, is transmitted at a third power level less than a third threshold, and in response to determining that the third transmission of the second radio is transmitted at a third power level less than the third threshold, causing the first radio to transmit a fourth transmission at a fourth power level, the fourth power level being determined based at least in part on the third power level and the third threshold.

In some embodiments, the fourth power level is less than or equal to the sum of the third threshold and a difference between third threshold and the third power level.

In some embodiments, the memory further stores instructions which, when executed by the one or more processors cause performance of sending, to the first processing circuit, messages each containing power level information for the first radio.

In some embodiments, the instructions, when executed by the one or more processors cause performance of sending the messages periodically, with a period of less than 60 seconds.

In some embodiments, the instructions, when executed by the one or more processors further cause performance of sending messages each containing power level information for the second radio.

According to an embodiment of the present disclosure, there is provided a device, including: a first radio; a second radio; and one or more first processors; and a memory storing first instructions which, when executed by the one or more first processors, cause performance of: determining that the first radio is not transmitting or that the first radio is transmitting at a first power level that is near-zero, and in response to the determination, causing the second radio to transmit, within a threshold time period of the determination, a second transmission at a second power level, wherein the second power level is determined based at least in part on a first threshold for transmission by the first radio.

In some embodiments, the second power level is less than or equal to double the first threshold.

In some embodiments, the second power level is less than or equal to a sum of the first threshold and a second threshold, wherein the second threshold is different than the first threshold.

In some embodiments, the first radio includes a first transmitting antenna, and the second radio includes a second transmitting antenna, co-located with the first transmitting antenna.

In some embodiments, the device further includes one or more second processors, wherein the memory further stores second instructions which, when executed by the one or more second processors, cause performance of sending, to the one or more first processors, a message indicating that the first power level is zero.

According to an embodiment of the present disclosure, there is provided an apparatus including: a first radio; a second radio; and means for processing, the means for processing being configured to: determine that a first transmission, of the first radio, is transmitted at a first power level less than a first threshold, and in response to determining that the first transmission of the first radio is transmitted at a first power level less than the first threshold, cause the second radio to transmit a second transmission at a second power level, wherein the second power level is determined based at least in part on the first power level and the first threshold.

In some embodiments, the second power level is less than or equal to the sum of the first threshold and a difference between the first threshold and the first power level.

### BRIEF DESCRIPTION OF THE DRAWINGS

In the following section, the aspects of the subject matter disclosed herein will be described with reference to exemplary embodiments illustrated in the figures, in which:

FIG. 1A is a block diagram of a user device, according to an embodiment.

FIG. 1B is a block diagram of a wireless communication system, according to an embodiment.

FIG. 2 is a block diagram of a cellular communication system, according to an embodiment.

FIG. 3A is graph of transmitted power as a function of time, according to an embodiment.

FIG. 3B is a schematic drawing of a method for power allocation, according to an embodiment.

FIG. 4A is graph of requested power as a function of time, according to an embodiment.

FIG. 4B is graph of requested power as a function of time, according to an embodiment.

FIG. 5A is a graph of specific absorption rate (SAR) as a function of time, according to an embodiment.

FIG. 5B is a graph of SAR as a function of time, according to an embodiment.

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Government regulations may impose limits on the specific absorption rate (SAR) and power density (PD) that may be transmitted by a user device such as a User Equipment (UE) (e.g., a mobile telephone). This imposes a limit on the transmitting power (which is proportional to SAR and depends on factors such as the technology, band, and antenna). The regulations may specify, for example, that the transmitted power from a transmitting antenna of a device with a single transmitting antenna may not exceed, within any time interval of a specified duration, an average value that, when multiplied by a conversion factor for the antenna, results in a certain absorbed power per kilogram (kg) exceeding a specified value (e.g., 1.2 watts/kilogram (W/kg)). These limits may prevent the device from reaching its maximum transmitted power capability, for example if in a device for a specific band at a specific antenna, the maximum transmission power is higher than the limit power, then the transmission will not reach this maximum power and will always be kept at that limit power. As used herein, “transmitted power” means the power level of a signal that is transmitted.

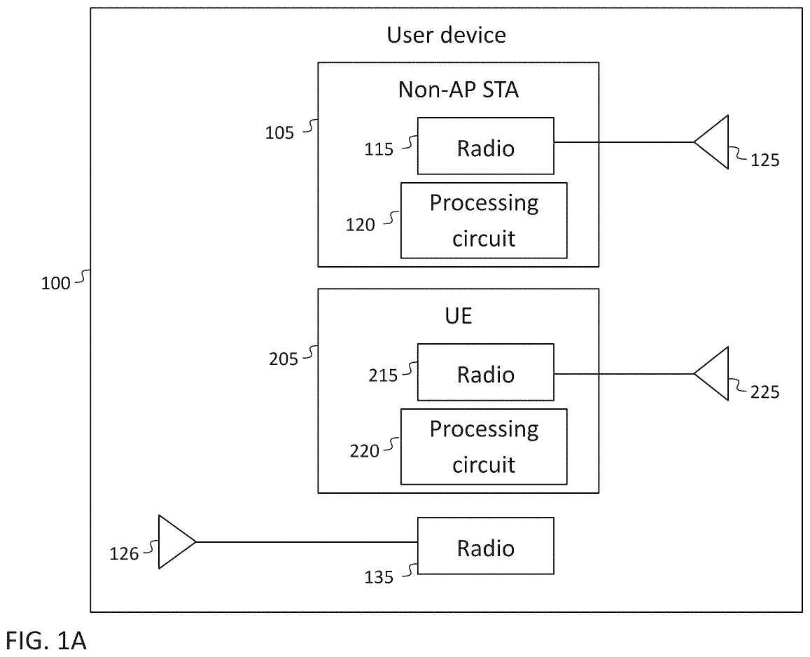

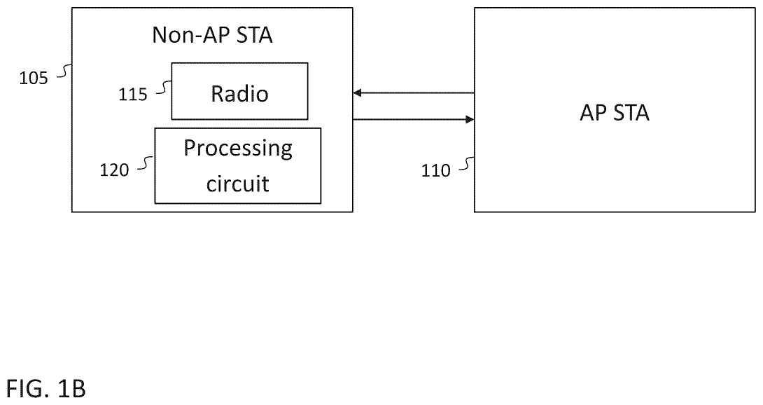

FIG. 1A shows a user device 100, such as a mobile telephone. The user device 100 includes a plurality of transmitting antennas 125, 225, 126, each of which may be connected to a respective radio. For example, as shown in FIG. 1A, the user device 100 may include a non-Access Point station (non-AP STA) 105, and a User Equipment (UE) 205. As used herein, a User Equipment is a circuit or device that provides access to a wireless (e.g., 5G cellular) network. As such, a user device (such as a mobile telephone, or a laptop with the capability to connect to a cellular network) may include a UE 205 and other elements. The user device 100 may further include one or more additional antennas or radios. For example, the UE 205 (and its radio 215) may use a first radio access technology (RAT) such as Long Term Evolution (LTE), and a third radio 135 in the user device 100 may use a second radio access technology such as New Radio (NR).

FIG. 1B shows a wireless communication system, such as a Wi-Fi system that complies with one of the 802.11 standards promulgated by the Institute of Electrical and Electronics Engineers (IEEE). In the system of FIG. 1B, data may be exchanged between a non-Access Point Station (non-AP STA) 105 and an Access Point Station (AP STA) 110. The exchanges of data may occur through wireless transmissions made by the non-Access Point Station 105 or by the Access Point Station 110. The non-Access Point Station 105 may include a radio 115 and a processing circuit 120. The processing circuit 120 may perform one or more of the methods described herein, e.g., transmitting data through the radio 115.

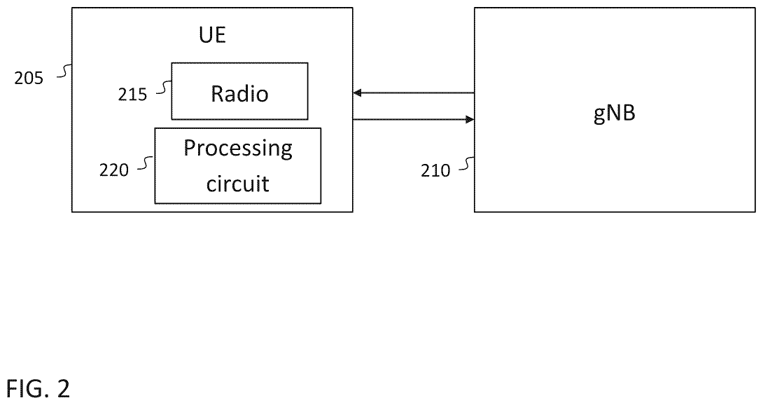

FIG. 2 shows a system including a UE 205 and a network node gNB 210, in communication with each other. The UE may include a radio 215 and a processing circuit (or a means for processing) 220, which may perform various methods disclosed herein. For example, the processing circuit 220 may receive, via the radio 215, transmissions from the network node (gNB) 210, and the processing circuit 220 may transmit, via the radio 215, signals to the gNB 210.

The regulatory limits on SAR may be specified as limits on time-averaged transmitted power from co-located antennas, so that, for example, the average SAR from co-located antennas over any time interval of length T_{avg} (which may be referred to as an averaging interval) is less than a specified level for compliance, referred to herein as SARcomp. Co-located antennas may be ones that are capable of simultaneously radiating in the direction of the user, e.g., antennas that are located on the same side of the user device 100. Two antennas that are on opposite sides of the user device 100 (e.g., the antenna 225 of the UE 205 of the user device 100 and the antenna 126 of the third radio 135 of the user device 100) may be considered not co-located, because when one such antenna radiates toward a user the other radiates away from the user.

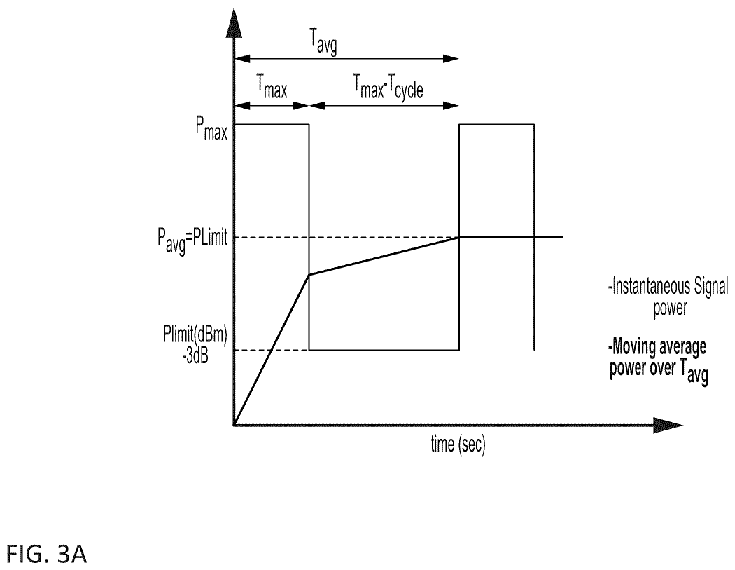

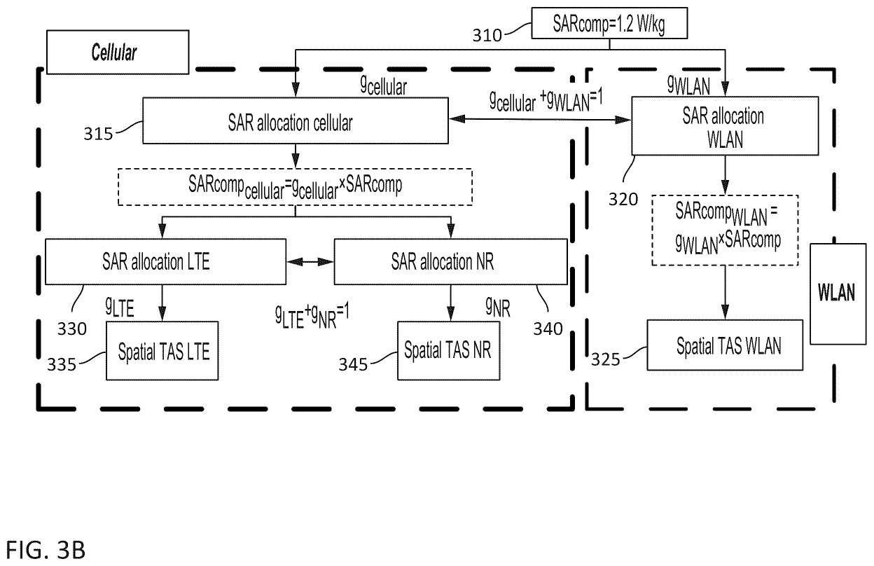

When only a single radio is operating in a user device 100, the user device 100 may achieve regulatory compliance (where regulatory compliance corresponds to the power level “Plimit” which corresponds to the regulatory SAR level “SARcomp” (e.g., Plimit may be defined, for a single operating radio, as the transmitted power level at which the SAR level reaches the regulatory compliance level SARcomp)), by radiating as illustrated in FIG. 3A, radiating during some time intervals at a power level Pₘₐₓ (which may be (i) a maximum power permissible under a standard (e.g., 802.11) that the radio complies with or (ii) a maximum transmitted power of which the radio is capable) that exceeds the regulatory limit, or “compliance power limit” Plimit and radiating during other time intervals at a lower power level, e.g., 3 dB below Plimit (or Plimit−3 dB, as shown). In such operating mode, during each time interval of length Tavg, the total time at which the transmitter radiates at the higher level (Tmax) may be determined based on the values of Pmax, Plimit and Tavg. A controller that controls the output power so as to meet a limit on time-averaged transmitted power (e.g., by alternating between two power levels as illustrated in FIG. 3A) may be referred to as a “Time Average SAR” (TAS) controller.

FIG. 3B shows a system and method for dynamically allocating transmitted power between three radios, (i) a wireless local area network (WLAN) radio, (ii) a Long Term Evolution (LTE) radio, and (iii) a New Radio (NR) radio. The total SAR 310 (e.g., 1.2 W/kg) is allocated in part to the WLAN radio and in part to the cellular radios; these fractions may be referred to as g_{WLAN} and g_{cellular} respectively (with g_{WLAN}+g_{cellular}=1), and the product of the total SAR with these respective fractions results in (i) a cellular power allocation 315 and (ii) a WLAN power allocation 320, which is allocated to the WLAN spatial TAS controller 325. Within the cellular power allocation, the power may be further divided into a first fraction g_{LTE} and a second fraction g_{NR} (with g_{LTE}+g_{NR}=1) to form an LTE power allocation 330 that is allocated to the LTE spatial TAS controller 335 and an NR power allocation 340 that is allocated to the NR spatial TAS controller 345.

Various methods may be employed to adjust the proportion of the total available power to each of the radios dynamically. For example, in a user device 100 with two radios, each radio may be given a default SAR allocation (and a corresponding power allocation), each of which may be a set fraction of the compliance SAR limit (SARcomp). In a first method referred to herein as switched proportioning, each of two radios in a user device 100 may be configured to send the other radio a message when it shuts off (e.g., stops transmitting) and when it starts transmitting. In such an operating mode, when a second radio is switched off, a first radio may start, first, to receive the history of power transmission of the second radio during the last Tavg period. Next, the first radio may (e.g., immediately, or within a time interval less than Tavg, or within less than a threshold time interval (which may be, e.g., 10 seconds, 30 seconds, or 50 seconds)) start to increase its available SAR level gradually while taking into consideration the first radio transmission history until it reaches a SAR allocation which is greater than its default allocation by the default allocation of the second radio. When the second radio is switched on again, the second radio may start to receive the history of power transmission of the first radio of the last T_{avg} period. In addition, for the next T_{avg} period, both radios will share their power transmission information where the first radio is gradually decreasing its allocated SAR level while the second radio is gradually increasing its allocated SAR level. The Tavg for each radio might be different.

For example, if (i) the second radio has a target SAR of SAR_{target} (which may correspond to the target power P_{target} of the second radio), (ii) the second radio is switched off at time k (with k<t), and (iii) there are M increments within Tavg (the averaging window), then the SAR available for the first radio, as a function of time, may be calculated as:

$$S A {R}_{available} ( t ) = S A {R}_{target} - \frac{1}{M} {\sum }_{n = t - M}^{k - 1} SAR ( n ) ,$$

and the power available for the first radio may similarly be calculated as:

$${P}_{available} ( t ) = {P}_{target} - \frac{1}{M} {\sum }_{n = t - M}^{k - 1} P ( n ) ,$$

where SAR(n) is the SAR of the second radio at time n, and P(n) is the power transmitted by the second radio at time n. The value SAR_{target} may be the SAR that the second radio would transmit when both radios are fully operating.

It will be appreciated that though the examples and embodiments described throughout the specification allude to multiple antennas using the same SAR level thresholds, different antennas may in some cases correspond to different individual SAR level thresholds based on factors such as hardware components, standardization changes, technology generation, etc.

When switched proportioning is used, the radios may communicate relatively infrequently, notifying each other only when they transition into, or out of, a zero-power state. As a result, it may not be possible for one radio to take advantage of the power allocation surplus made available when the other radio reduces its transmitted power without shutting off entirely.

As described herein, a “zero-power” state may refer to a state in which a device and/or component is not transmitting, or is transmitting at a power level such that a measurement of the power level of the transmission is not detectable or is of such insignificant magnitude that the operating state of the device and/or component may be effectively considered zero without any impact to other operations. As used herein, the term “near-zero” may also be used to describe a power level of a transmission that is similarly insignificant and effectively non-impactful to other device/component operations, but still measurable. In one non-controlling illustrative example, a first antenna may transmit a signal measuring 0.0001 W/kg of power level, though a system including the first antenna may not be required to react to signals with a power level below 0.05 W/kg, rendering the transmission of the first antenna “near-zero.”

In a second method referred to herein as periodic proportioning each radio periodically sends to the other radio messages containing transmitted power information. When a first radio sends such messages, the messages may inform the second radio of the power that the first radio transmitted during the past averaging interval (this may be referred to as “time-averaged transmitted power” or as “time-averaged power level”), or of the average power that the first radio transmitted during the most recent time increment (this may be referred to as “increment-average transmitted power” or as “increment-average power level”), each time increment being the interval between consecutive reports. When the first radio receives a report from the second radio indicating that the second radio has not been using its full allocated SAR (for example, it is been transmitting at a low power for a while), the first radio may increase its allocated SAR gradually so as to use the unused allocation. When periodic proportioning is used, the radios may communicate frequently, e.g., at the end of each time increment. This relatively frequent reporting may carry a cost in terms of overhead, but it may have the advantage of making it possible for one radio to take advantage of the power allocation surplus made available when the other radio reduces its transmitted power without shutting off entirely.

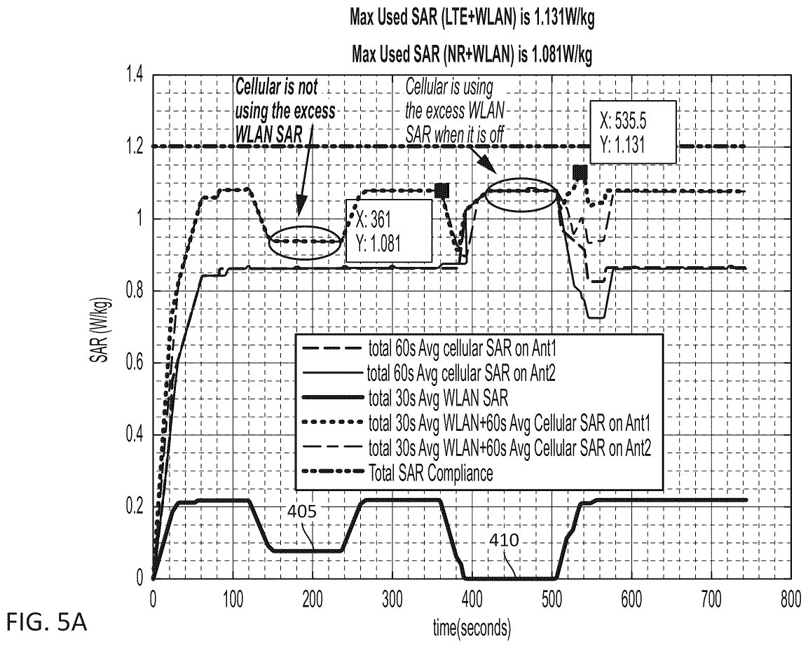

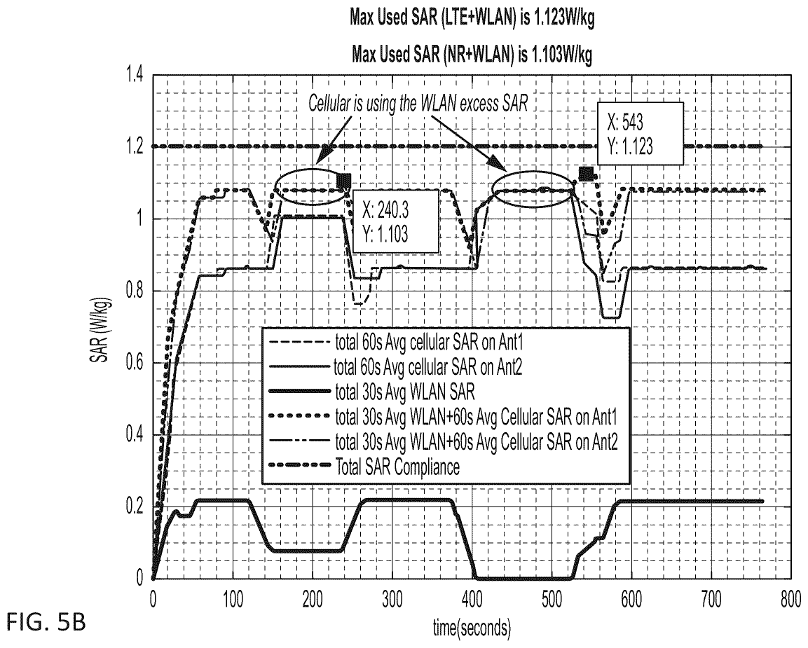

When periodic proportioning is used, the first radio may select (e.g., a processing circuit associated with the first radio may select) to boost its lower power level by an amount equal to the gradual increase of the allocated time-averaged SAR which will increase the average SAR level of the first radio slowly while keeping the total average SAR below the compliance level. In another embodiment, the first radio might select to increase the duration of its maximum allowed power level using the abundant SAR allocation from the second radio. This may introduce a fast increase in the average SAR level of the first radio and an overshoot may occur; such an overshoot may be absorbed by a suitable margin (for example 10%) from the target SAR compliance level. This may be seen in FIG. 5B, where the total target SAR level is 1.2 W/kg while the total SAR at any antenna is below it. In another embodiment, if the second radio was using a lower SAR allocation (where the excess SAR was being used by the first radio) then the first radio might decide to lower its transmitted power for a period of time until the second radio could acquire its full SAR allocation. Similar methods may also be used in the switched proportioning method.

In some embodiments, when the instantaneous SAR transmitted by the second radio is reduced (e.g., when the second radio is shut off), any instantaneous SAR that the second radio would otherwise have used becomes immediately available, at its time instant, to the first radio (less any margin needed to account for imperfect (e.g., delayed) communication between the radios), and the first radio may immediately begin transmitting with an instantaneous SAR equal to the total instantaneous SAR available to it (e.g., with the instantaneous SAR it would have transmitted had the instantaneous SAR transmitted by the second radio not been reduced, plus any instantaneous SAR that the second radio would otherwise have used, less any needed margin). For example if radio 2 is switched off at time t1 then the instantaneous SAR that would have been transmitted by radio 2 at time t1 will be available to radio 1 at time t1, and not before that. When the second radio is switched off, the time-averaged SAR of the second radio decreases gradually and, if the first radio immediately takes advantage of the newly available SAR, its time-averaged SAR increases gradually at the same rate. If the instantaneous SAR that the second radio would have produced, had it not been switched off, is time-varying (e.g., occasionally exceeding the maximum permissible time-averaged SAR) then the same time-varying SAR immediately becomes available to the first radio.

In other embodiments, each radio may send the other radio a message with transmitted power information each time it changes its transmitting power level. The methods described above are readily generalized to a user device 100 having more than two radios. For example, if a user device has a WLAN radio and two cellular radios (for respective RATs) then the total power allocated to the cellular radios may be adjusted based on the power transmitted by the WLAN radio. Each method may be generalized (in a method that may be referred to as spatial TAS) to the case in which a user device 100 includes non-co-located antennas by disregarding, when determining the power to be transmitted by any antenna, the power transmitted by any non-co-located antennas. For example, in a user device 100 having a first antenna, a second antenna, and a third antenna, with (i) the first antenna being co-located with the second antenna, (ii) the third antenna not being co-located with the first antenna, and (iii) the third antenna not being co-located with the second antenna, the spatial TAS method may (i) determine the power to be transmitted by the first antenna, taking the power radiated by the second antenna into account, and not taking the power radiated by the third antenna into account, and (ii) determine the power to be transmitted by the second antenna, taking the power radiated by the first antenna into account, and not taking the power radiated by the third antenna into account. As another example, if (i) the first antenna is co-located with the third antenna, (ii) the second antenna is co-located with the third antenna, and (iii) the first antenna is not co-located with the second antenna, then the spatial TAS method may (i) determine the power to be transmitted by the first antenna, taking the power radiated by the third antenna into account, and not taking the power radiated by the second antenna into account, (ii) determine the power to be transmitted by the second antenna, taking the power radiated by the third antenna into account, and not taking the power radiated by the first antenna into account, and (iii) determine the power to be transmitted by the third antenna, taking into account the joint effect of the power radiated at both the first and the second antenna. The power control algorithms may be implemented in software executed in respective processing circuits in radio chips, each radio chip being a part of a respective radio. In some embodiments, several radios may share a radio chip, and the power control algorithms for the radios may be implemented in a shared processing circuit in the radio chip, e.g., a shared processing circuit may execute different control software for each of the radios.

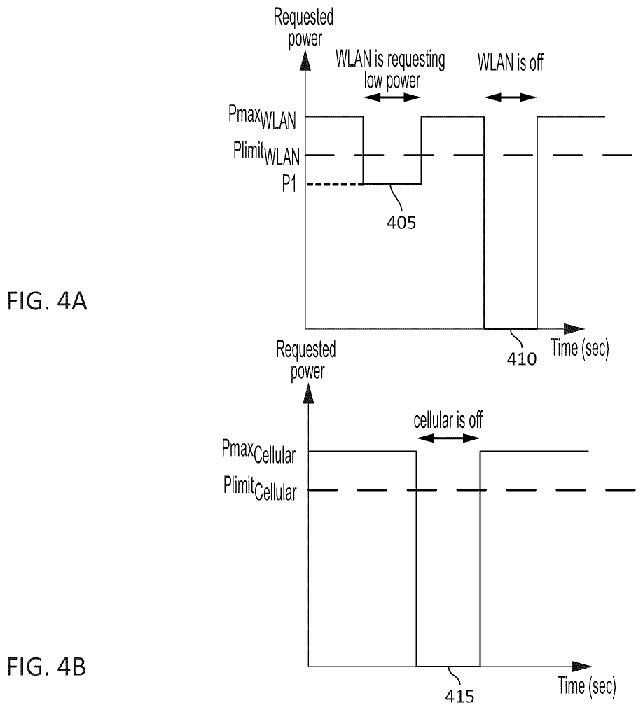

FIG. 4A shows a graph of the requested power levels to be transmitted, as a function of time, by a WLAN radio of a user device 100. During a low-power interval 405, the WLAN radio transmits at a power level that is less than its default allocation Plimit_{WLAN}, and during a zero-power interval 410, the WLAN radio transmits at a power level of zero (i.e., the radio does not transmit). Similarly, FIG. 4B shows a graph of the requested power levels to be transmitted, as a function of time, by the (one or more) cellular radios of a user device 100. During a zero-power interval 415, the cellular radios transmit at a power level of zero (i.e., the radios do not transmit).

FIG. 5A is a graph showing the average SAR of the power transmitted by the cellular radios (the antennas of which, Ant 1 and Ant 2, are assumed to be uncoupled) as a function of time, in an embodiment using switched proportioning, when the WLAN radio is requested to transmit power, as function of time, as illustrated in FIG. 4A. During the interval 405 during which the WLAN radio transmits at reduced power, the allocated SAR level of the two cellular radios is unchanged, in part because they are not aware of the reduction in WLAN transmitted power. As a result, the total average power transmitted by the user device 100 during this interval is reduced (and the cellular radios do not use the available surplus power (SAR) allocation). At the beginning of the interval 410 during which the WLAN radio is shut off, however, the WLAN radio sends a message to the cellular radios notifying them that the WLAN radio is transitioning to a zero-power state. The cellular radios then increase their SAR allocation gradually to take advantage of the available surplus SAR allocation, and the total average power (SAR) transmitted by the user device 100 is the same as it is when each of the radios is transmitting at its default allocation.

FIG. 5B is a graph showing the average SAR of the power transmitted by the cellular radios as a function of time, in an embodiment using periodic proportioning, when the WLAN radio is requested to transmit power, as function of time, as illustrated in FIG. 4A. At the beginning of the interval 405 during which the WLAN radio transmits at reduced power (and periodically during this interval), the WLAN radio sends a message to the cellular radios informing them of the reduction in WLAN average transmitted power, and (unlike in the embodiment corresponding to FIG. 5A), the average power (SAR) of the two cellular radios is increased, as the cellular radios take advantage of the corresponding available surplus SAR allocation. Similarly, at the beginning of the interval 410 during which the WLAN radio is shut off (and periodically during this interval), the WLAN radio sends a message to the cellular radios notifying them that the WLAN radio is transmitting no power. The cellular radios then again increase their SAR allocation gradually to take advantage of the available surplus SAR allocation, and the total average power (SAR) transmitted by the user device 100 is, during both the low-power interval 405, and the zero-power interval 410, the same as it is when each of the radios is transmitting at its default allocation.

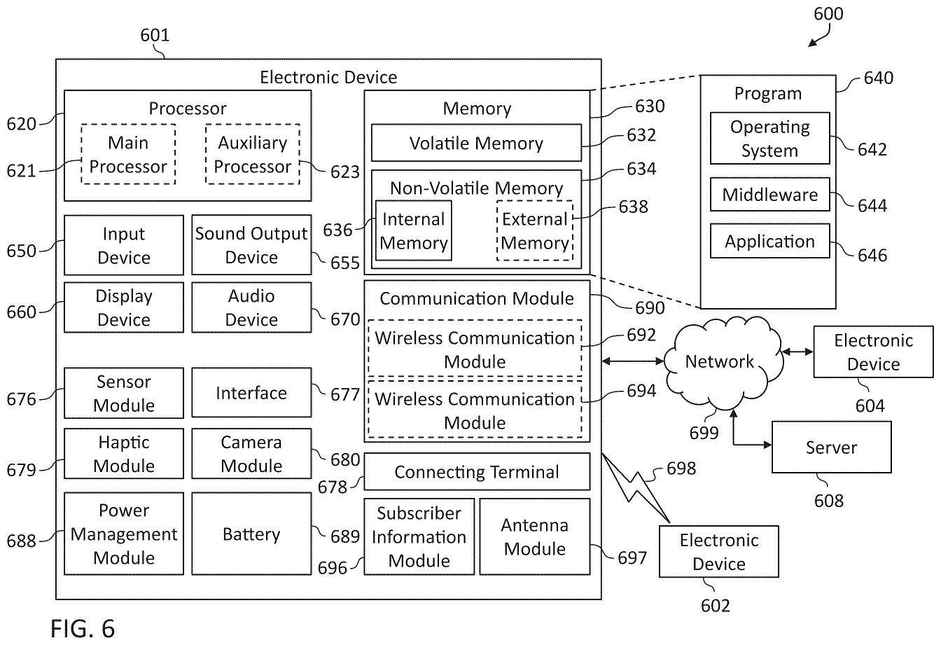

FIG. 6 is a block diagram of an electronic device (such as the user device 100) in a network environment 600, according to an embodiment.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™M, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A device, comprising:
a first radio;
a second radio; and
one or more processors; and
a memory storing instructions which, when executed by the one or more processors, cause performance of:
determining that a first transmission, of the first radio, is transmitted at a first power level greater than zero and less than a first threshold, and
in response to determining that the first transmission of the first radio is transmitted at a first power level less than the first threshold, causing the second radio to transmit a second transmission at a second power level,
wherein the second power level is determined based at least in part on the first power level and the first threshold.

2. The device of claim 1, wherein the second power level is less than or equal to the sum of the first threshold and a difference between the first threshold and the first power level.

3. The device of claim 1, wherein the second power level is less than or equal to the sum of a second threshold and a difference between the first threshold and the first power level, wherein the second threshold is different than the first threshold.

4. The device of claim 1, wherein the first power level of the first radio is a time-averaged power level of the first radio.

5. The device of claim 1, wherein the first power level is an increment-average power level of the first radio.

6. The device of claim 1, wherein the first threshold is a set fraction of a compliance power limit.

7. The device of claim 1, wherein the first radio comprises a first transmitting antenna, and the second radio comprises a second transmitting antenna, co-located with the first transmitting antenna.

8. The device of claim 7, further comprising a third radio comprising a third transmitting antenna, the third transmitting antenna not being co-located with the second transmitting antenna,
wherein the instructions, when executed by the one or more processors, further cause performance of determining the second power level based on quantities not including a power level of a transmission transmitted by the third transmitting antenna.

9. The device of claim 1, wherein the instructions, when executed by the one or more processors, further cause performance of:
determining that a third transmission, of the second radio, is transmitted at a third power level less than a third threshold, and
in response to determining that the third transmission of the second radio is transmitted at a third power level less than the third threshold, causing the first radio to transmit a fourth transmission at a fourth power level, the fourth power level being determined based at least in part on the third power level and the third threshold.

10. The device of claim 9, wherein the fourth power level is less than or equal to the sum of the third threshold and a difference between third threshold and the third power level.

11. The device of claim 9, wherein the memory further stores instructions which, when executed by the one or more processors cause performance of sending, to the first processing circuit, messages each containing power level information for the first radio.

12. The device of claim 11, wherein the instructions, when executed by the one or more processors cause performance of sending the messages periodically, with a period of less than 60 seconds.

13. The device of claim 11, wherein the instructions, when executed by the one or more processors further cause performance of sending messages each containing power level information for the second radio.

14. A device, comprising:
a first radio;
a second radio; and
one or more first processors; and
a memory storing first instructions which, when executed by the one or more first processors, cause performance of:
determining that the first radio is not transmitting or that the first radio is transmitting at a first power level that is near-zero, and
in response to the determination, causing the second radio to transmit, within a threshold time period of the determination, a second transmission at a second power level,
wherein the second power level is determined based at least in part on a first threshold for transmission by the first radio.

15. The device of claim 14, wherein the second power level is less than or equal to double the first threshold.

16. The device of claim 14, wherein the second power level is less than or equal to a sum of the first threshold and a second threshold, wherein the second threshold is different than the first threshold.

17. The device of claim 14, wherein the first radio comprises a first transmitting antenna, and the second radio comprises a second transmitting antenna, co-located with the first transmitting antenna.

18. The device of claim 14, further comprising one or more second processors, wherein the memory further stores second instructions which, when executed by the one or more second processors, cause performance of sending, to the one or more first processors, a message indicating that the first power level is zero.

19. An apparatus, comprising:
a first radio;
a second radio; and
means for processing,
the means for processing being configured to:
determine that a first transmission, of the first radio, is transmitted at a first power level less than a first threshold, and
in response to determining that the first transmission of the first radio is transmitted at a first power level less than the first threshold, cause the second radio to transmit a second transmission at a second power level,
wherein the second power level is determined based at least in part on the first power level and the first threshold.

20. The apparatus of claim 19, wherein the second power level is less than or equal to the sum of the first threshold and a difference between the first threshold and the first power level.
